(19) United States
(12) Patent Application Publication
(10) Pub. No.: US 2006/0128563 A1
(43) Pub. Date: Jun. 15, 2006

(54) Method for manufacturing a non-fogging element and device for activating such an element

(75) Inventor: Stefan Vogl, Miltach (DE)

Correspondence Address: DAVIDSON, DAVIDSON & KAPPEL, LLC, 485 SEVENTH AVENUE, 14TH FLOOR, NEW YORK, NY, 10018, US

(73) Assignee: Flabeg GmbH & Co., KG, Fuerth (DE)

(21) Appl. No.: 11/296,631

(22) Filed: Dec. 7, 2005

Related U.S. Application Data
(60) Provisional application No. 60/634,475, filed on Dec. 9, 2004.

(51) Int. Cl. B01J 23/00

(52) U.S. Cl. 502/350

(57) ABSTRACT

A method for manufacturing an element includes providing a surface layer including a photocatalytic material, and subjecting the surface layer to an activation process including reactively treating the surface layer.

Priority is claimed to provisional application No. 60/634,475, filed Dec. 9, 2004, the entire subject matter of which is hereby incorporated by reference herein.

The present invention relates to a method for manufacturing an element, in which a surface layer of a photocatalytic material is subjected to an activation step. The present invention further relates to a device for activating a surface layer of a photocatalytic material of such an element.

### BACKGROUND

In many applications of glasses, such as rearview mirrors or windshields of motor vehicles, window panes of buildings, traffic mirrors, lenses, or glass covers for instruments, it is desirable to keep the respective glass free of condensation even at comparatively low ambient temperatures and high ambient humidity. For glasses, this can be achieved by manufacturing a non-fogging element by providing the surface with an anti-fogging coating usually having so-called “hydrophilic” or “super-hydrophilic” properties.

In this context, the hydrophilicity can be determined based on the so-called “contact angle” that the boundary, or sides, of a water drop on the surface of the element forms with the element surface. For uncoated glasses, this wetting angle is usually between about 40° and 60°. In contrast, a surface is referred to as being “hydrophilic” if the wetting angle is smaller than about 20°. In the case of large wetting angles of, for example, more than 100°, one speaks of “hydrophobic surfaces”. In comparison, the so-called “super hydrophilicity” is present when the wetting or contact angle is less than about 10°, preferably less than about 5°.

When a glass surface that is hydrophilic or super-hydrophilic in this sense is wetted with water, for example, due to condensation, the resulting water drops will immediately form a comparatively homogenous film of water. Unlike the presence on the glass surface of separate, individualizable water drops which may, in particular, be irregular in shape and size, such a homogenous water film affects the passage of light through the glass only insignificantly so that no appreciable hazing or adverse effect will occur for the user. Consequently, a glass can be made non-fogging in the sense described above by applying a hydrophilic surface coating.

To do this, i.e., to manufacture a non-fogging element by depositing a hydrophilic coating on the surface of a glass substrate, it is known, for example, from German Utility Patent DE 296 23 901 U1 or European Patent EP 1 254 870 A2, to provide a substrate with a substantially transparent coating of a photocatalytic material, in particular, with titanium dioxide (TiO₂). The entire subject matters of DE 296 23 901 U1 and European Patent EP 1 254 870 A2 are hereby incorporated by reference herein. The photocatalytic material acts so as to make the surface of the coating hydrophilic in the sense described above. In this context, it is assumed that irradiation with light of an appropriate wavelength causes hydroxyl radicals (OH⁻) and, by a secondary reaction, hydroperoxy radicals (HOO⁻) and peroxyl radical anions (O₂⁻) to form at the surface under the photocatalytic action of the photocatalytic material; these radicals and radical anions being able to oxidize organic-chemical compounds adhering to the surface of the coating. In this process, carbon dioxide and water are ultimately produced in a cascade of reactions, in which water and oxygen from the air also participate. In this manner, the surface of the coating is freed from greases, oils or other organic-chemical contaminations, finally leaving only physisorbed water together with the terminal OH groups of the coating, as a result of which the coating becomes hydrophylic.

Thus, during the manufacture of such a non-fogging element, the substrate is provided with a substantially transparent coating of a photocatalytic material which, after photoexcitation, makes the surface of the element hydrophilic. For first-time use of such a non-fogging element, moreover, a so-called “activation” of the coating is required. In accordance with the concept of German Utility Patent DE 296 23 901 U1, this activation is accomplished by irradiating the coating using a suitable light source; the intention being for the wavelength of the light used to have a higher energy than the band gap energy of the photocatalyst. Once the surface of the photocatalytic coating is made hydrophilic or super-hydrophilic by this activation, the hydrophilicity of the surface is maintained for a certain period of time, even if the substrate is stored in the dark. However, the hydrophilicity gradually disappears over time, which is especially attributed to contaminations attaching to the hydroxyl groups of the coating surface. However, the hydrophilicity, and thus the anti-fogging property of the element, can be restored in a relatively simple manner by subjecting the surface to photoexcitation once again. With regard to this “refreshment” of the surface hydrophilicity, the radiation requirements in terms of intensity and duration of irradiation are clearly lower than for the first activation. For example, when using such a non-fogging element in the rearview mirror of a motor vehicle, it may be perfectly sufficient, for the purpose of re-activating the hydrophilic surface coating, to operate the motor vehicle in daylight during a period of only a few hours to completely restore the hydrophilic property of the surface coating.

However, during the manufacture of such a non-fogging element, the activation step for the first activation of the photocatalytic surface coating is comparatively costly. For this purpose, the substrate generally needs to be irradiated with UV light with an intensity of several hundred watts per square meter during a period of several hours after the photocatalytic coating has been applied. For an industrial process for the production, in particular, for the large-scale production of such non-fogging elements, this activation is therefore comparatively inconvenient in terms of both the time and energy required for the treatment.

### SUMMARY OF THE INVENTION

It is therefore an object of the present invention to provide a method for manufacturing a non-fogging element which, in terms of the treatment time and associated costs required for activating the surface layer, is suitable also for large-scale production. A further object is to provide a device which is suitable for carrying out the activation step in such a method.

The present invention provides a method for manufacturing an element, wherein the surface layer is reactively treated during the activation step.

In this context, it is proposed, in particular, that suitable conditions for the surface activation during the activation step be established in terms of the ambient conditions (such as temperature, pressure) and potential co-reactants for the surface layer, allowing the hydroxyl groups to be provided at the surface by chemical reactions, which is the intended purpose of the activation.

In this connection, the present invention is based on the idea that a manufacturing method which is also suitable for large-scale production should be aimed consistently at comparatively short treatment times of individual elements and at keeping energy consumption relatively low. Surprisingly, it turns out that the photoexcitation of the surface layer, which has previously been considered indispensable for providing the hydroxyl groups, can generally be replaced by chemical pretreatment of the surface layer; relatively short treatment times being achievable by suitable selection of co-reactants and reaction conditions. Therefore, it is proposed to carry out the activation step chemically, the surface layer being reactively treated in the process.

The element in question could be essentially completely composed of the photocatalytic material. However, in an embodiment the surface layer is advantageously formed by a coating of the photocatalytic material applied to a substrate, which allows for use, especially as an automotive mirror, or the like. In this connection, in particular, the substrate provided with the coating can also be subjected to a subsequent activation step in the manner of an intermediate product. Advantageously, the method may be used for manufacturing a non-fogging element in which the substrate is provided with a substantially transparent coating of a photocatalytic material which, after photoexcitation, makes the surface of the element hydrophilic.

The present invention also provides a device for activating a surface layer of a photocatalytic material of an element, the device including a conveying device for the element with which is associated a device for reactive treatment of the surface layer. The device used for reactive treatment of the surface layer can be suitable means for plasma treatment or also for corona discharge. In an embodiment, a number of gas burners is used as the device for reactive treatment of the coated substrate.

In this case, the or each gas burner may be positioned relative to the conveying device in such a manner that the visible flame tip of the gas flame is is located slightly, for example about 10 mm to 20 mm, above the surface of a passing substrate. This enables reliable, stable and reproducible treatment results to be obtained by the oxidizing properties of the gas flame, the presence of free radicals, and the water vapor released during combustion.

The device can be designed for sequential treatment of a plurality of separate elements by suitable selection of the conveying device. In particular, provision can also be made to treat convex or curved elements having a relatively large surface area. These elements can, in particular, be so-called “spherical caps” from which are made, for example, outside mirrors for passanger cars, for trucks, or buses. To ensure uniform activation over the surface area for such applications, there is provided a plurality of gas burners which are arranged such that they adapted to an intended substrate contour in terms of the positioning and orientation of their outlets. In this connection, provision can be made to activate spherical caps using a plurality of individual burners arraned according to the contour of the spherical cap. The uniformity of the activation can be further increased by rotating the spherical caps during the flame treatment. If the spherical cap has different (outer/inner) surface speeds, the resulting inhomogeneities may be compensated for by different burner intensities or auxiliary burners.

### BRIEF DESCRIPTION OF THE DRAWINGS

An exemplary embodiment of the present invention will be explained in more detail with reference to a drawing, in which:

FIG. 1 is a schematic view of a device for activating a substrate coated with a photocatalytic semiconductor material.

FIG. 2 shows an alternative embodiment of the device of FIG. 1.

FIG. 3 is a diagram showing the dependence of a contact angle on a mass ratio.

In the Figures, like reference numerals denote like parts.

### DETAILED DESCRIPTION

The reactive treatment of the surface could be accomplished, for example, by the action of a sufficiently high temperature, in particular under atmospheric conditions, for example, in an oven. Alternatively or additionally, concepts such as plasma treatment in vacuum or plasma treatment in air could, in principle, be used, given the appropriate selection of the process parameters. In one advantageous embodiment, however, a corona treatment is proposed for the reactive treatment of the surface layer during the activation step; the surface being treated with a corona discharge when carrying out the activation step. However, relatively short treatment times and a relatively low level of equipment complexity for carrying out the activation step can be achieved in an advantageous embodiment by reactively treating the surface layer with a gas flame.

In order to activate the surface coating by exposure to a gas flame, a substrate coated with the photocatalytic material is advantageously moved past the gas flame; the gas flame being positioned such that the flame tip is located slightly, for example about 10 mm to 20 mm, above the substrate surface. This is because, due to the oxidizing properties of a gas flame, the presence of free radicals (such as hydroxyl radicals HO⁻, hydroperoxyl radicals HOO⁻ and hydroperoxyl radical anions HOO⁻), and the water vapor released during combustion, the best treatment results are expected to be obtained when the flame tip is in direct contact with the substrate surface. In the process, the gas flame may be applied to the coated side of the substrate.

A high effectiveness of the treatment of the coated substrates can be achieved by conveniently moving the substrate past the gas flame at a rate between 0.1 and 10 cm/s, for example at about 2.5 cm/s.

The flame treatment of the surface may be carried out using a plurality of slit burners. The gas burner or burners is/are advantageously operated with excess air so that the burner flame burns blue. To this end, the gas flame is advantageously supplied with a fuel gas stream and an oxidant stream; the mass ratio being set appropriately. For this purpose, the ratio of the oxidant stream, in particular air, and the fuel gas stream may be set to a value above 10 so as to maintain a relatively clearly pronounced excess of air.

Advantageously, the activation step is carried out in ambient atmosphere or under inert atmosphere.

With respect to material selection, titanium dioxide (TiO₂) has proven advantageous for the intended use as a photocatalytic material or a hydrophilic surface coating. Therefore, the photocatalytic material applied to the substrate is advantageously a titanium oxide coating.

The non-fogging element can be used for any desired purpose, for example, as a windshield in a motor vehicle, as a window pane in the exterior facade of a building, as a traffic mirror, a lens, or the like. In an embodiment, however, the non-fogging element produced is a mirror, for example for use in a motor vehicle.

In an embodiment, a device for reactive treatment of a substrate, in particular a gas burner, is used to activate a substantially transparent coating of a photocatalytic material applied to a substrate.

Avantages of the present invention include that, because the surface layer is activated in a reactive way, the disadvantages associated with the otherwise required photoactivation can be avoided, especially with respect to the associated energy requirement and the required treatment time. For example, due to the reactive treatment of the surface layer, the time needed for the coated substrate to pass through the activation system which, in the case of photoactivation by UV radiation is typically about 3 hours, may be reduced to a treatment time of about 6 seconds for gas flame based reactive treatment. In the manufacture of coated mirrors for the automotive industry, the specific energy requirement for activation can be reduced from about 200 watt-hours per mirror (photoactivation by UV radiation) to about 2 watt-hours per mirror (gas flame based reactive treatment). In this connection, the contact angle determined after the treatment, which is indicative of the degree of hydrophilicity, as well as the change of the contact angle over time after completion of the activation are comparable in both cases.

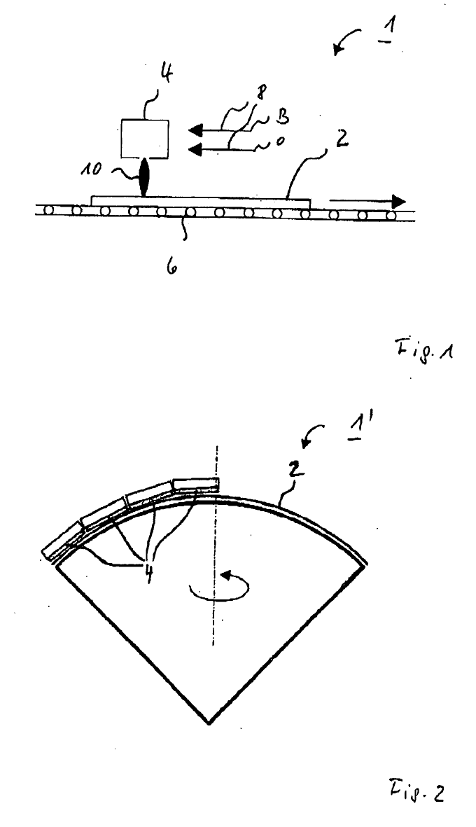

Device 1 of FIG. 1 is intended for the so-called “activation” of a substrate 2 coated with a photocatalytic material. This substrate 2, which in the exemplary embodiment is intended for the manufacture of rearview mirrors for motor vehicles and the main body of which is therefore substantially composed of glass, is provided on its surface with a coating which has hydrophilic or super-hydrophilic properties and which, when wetted with water, therefore forms a comparatively homogenous film of water, which affects the passage of light through the glass only insignificantly. To this end, substrate 2 is coated with a photocatalytic semiconductor material, in the exemplary embodiment with titanium dioxide, in a manner known per se before it is fed to device 1. The coating may be applied by sputtering, vapor deposition, reactive deposition from the gas phase (so-called “CVD”=chemical vapor deposition), sol-gel coating, etc. The application of the coating onto substrate 2 can be accomplished using known processes, such as those discussed above in the “Background” section.

A substrate 2 provided with a titanium coating in this manner has, in principle, super-hydrophilic properties at the coated surface. The hydrophilicity is maintained for a certain period of time, even if substrate 2 is stored in the dark. However, the hydrophilicity gradually disappears over time, but can be restored in a relatively simple manner by subjecting the surface to photoexcitation, for example, by daylight. However, the development of super-hydrophilicity in the surface of coated substrate 2, and thus the manufacture of a non-fogging element formed by coated substrate 2, requires that coated substrate 2 be subjected to a so-called “activation step” after the titanium dioxide coating is applied. To this end, the surface coating must be made super-hydrophilic by a suitable treatment in a treatment step prior to the first use of coated substrate 2; it being assumed that in this step a number of hydroxyl groups sufficient to be able to produce the desired super-hydrophilicity are provided in the surface coating.

To carry out this activation step on the already coated substrate 2, and thus to complete the manufacture of the non-fogging element, device 1 is designed in a specific way. In this connection, device 1 is intended, in particular, for use in large-scale production, and is therefore designed with a view to particularly short treatment times for coated substrates 2 and comparatively high throughput rates with limited energy consumption. To be able to achieve these design goals, device 1 is designed for the concept of activating coated substrates 2 by reactive treatment. In accordance with the design, such a reactive treatment is carried out, in particular, by establishing suitable ambient conditions and parameters so as to supply reactive radicals or substances to substrate 2 as it passes through device 1; the reactive radicals or substances freeing the surface of the coating from adhering contaminations by chemical reactions via oxidations (using hot oxygen, HOO⁻, OH⁻ radicals), ultimately producing a sufficient number of hydroxyl groups at the coated surface.

Such a reactive treatment could be carried out, for example, by a purely thermal treatment in an appropriately selected ambient atmosphere, or also by exposure to a corona discharge. In the exemplary embodiment, however, device 1 is designed for carrying out the activation step by gas flame treatment of the surface coating applied to substrate 2. To this end, device 1 includes a gas burner 4 as the device for reactive treatment of coated substrate 2. The gas burner is associated with a conveying device 6 for coated substrate 2, the conveying device allowing coated substrate 2 to be moved past gas burner 4 in a suitable manner.

As indicated by arrows 8, gas burner 4 can be supplied with both a fuel gas B and an oxidant O. The fuel gas B may be, for example, methane, ethane, ethylene, acetylene, propane, butane, natural gas, hydrogen, mixtures thereof or the like.

During the operation of device 1, the operating parameters of gas burner 4 are adjusted, in particular, so as to achieve a particularly good treatment results on coated substrate 2. In this connection, among other things, the realization is taken into account that, due to the oxidizing properties of burner flame 10, the presence of free radicals, and the water vapor released during combustion, the best treatment results are expected to be obtained when the flame tip is in direct contact with the substrate surface. In view of this, gas burner 4 is positioned relative to conveying device 6 in such a manner that the flame tip of burner flame 10 is located about 15 mm above the surface of passing substrate 2. In such a constellation, for example, slightly contaminated surfaces, which have been subjected, for example, to pre-cleaning using a suitable washing device, can be cleaned in only a few seconds.

In the alternative embodiment of FIG. 2, device 1′ is designed for treatment of a contoured substrate 2, for example, a spherical cap. In this case, to be able to reliably treat a comparatively large surface in a relatively short treatment time, device 1′ is provided with a plurality of gas burners 4 which are adapted to the intended contour of substrate 2 in terms of the positioning and orientation of their outlets. It is provided during operation of device 1 for the spherical caps to be rotated as they are flame-treated, thereby achieving a particularly uniform activation over the surface area. Possible differences in the surface speed of the spherical cap may be compensated for by suitable selection of different burner intensities or using auxiliary burners (not shown in FIG. 2).

In device 1 and also in device 1′, to ensure a particularly favorable treatment result, the feed streams of fuel gas B and oxidant O can each be controlled separately, allowing a particularly favorable ratio of the two gas streams to be set as a function of the operating point. For particularly good treatment results, this mass ratio is set such that the burner flame burns blue, i.e., is operated with excess air. Substrate 2 is moved past burner flame 10 at a rate between 0.1 and 10 cm/s, for example at about 2.5 cm/s.

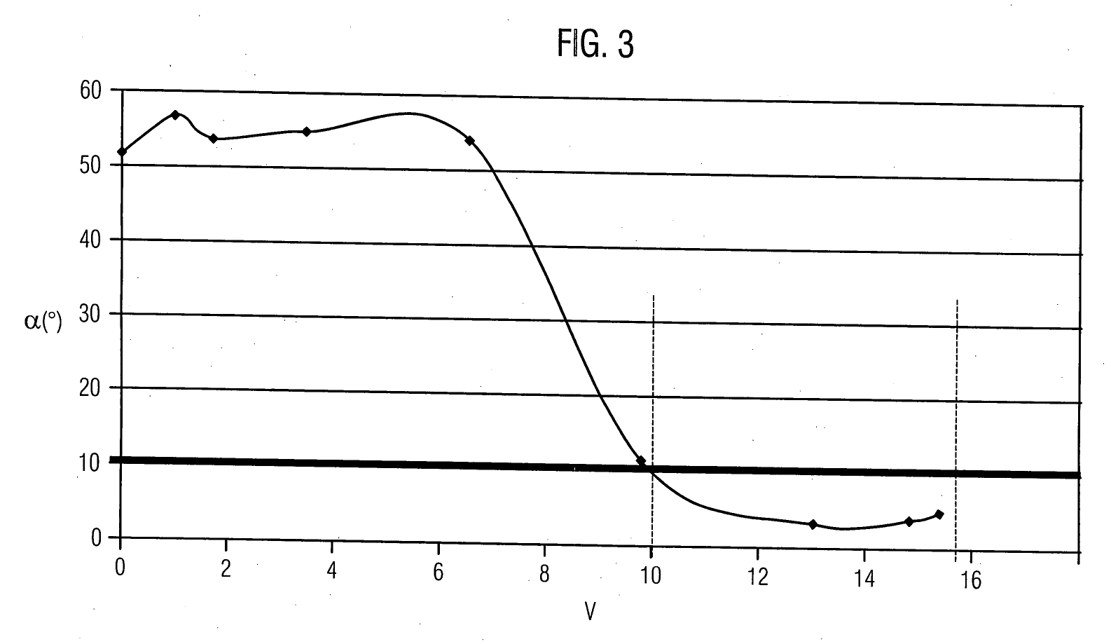

To illustrate the results that are obtainable in the process, the dependence of the so-called “contact angle” a on the ratio V between the oxidant stream (or air stream) and the fuel gas stream is shown in the form of a diagram in FIG. 3. In this context, contact angle a, which is used here as a measure of the hydrophilicity of coated substrate 2, is the angle that the boundary of a water drop on the surface of the element forms with the element surface. For uncoated glasses, this wetting angle is usually between about 40° and 60°. In contrast, a surface is referred to as being “hydrophilic” if the wetting angle is smaller than about 20°. In the case of large wetting angles of, for example, more than 100°, one speaks of “hydrophobic surfaces”. In comparison, the so-called “super hydrophilicity” is present when the wetting or contact angle is less than about 10°, preferably less than about 5°.

In the diagram of FIG. 3, this contact angle a is plotted as a function of ratio V for a coating system, in which the gas burner 4 used is a type SK 02-380-003 ribbon burner of the Webber company, which has a cast steel burner body, flame strips of stainless steel segments, and a width of 200 mm, and which can be operated with natural gas at an inlet pressure of 70 mbar and air at an inlet pressure of 6 bar. As can be inferred from the results shown in the diagram, once ratio V exceeds a value of about 10, that is, when there is a clear excess of air, contact angle a decreases to values below about 10°, so that so-called “super-hydrophilicity” of the of coated substrates 2 is attainable.

What is claimed is:

1. A method for manufacturing an element, comprising:
providing a surface layer including a photocatalytic material; and
subjecting the surface layer to an activation process including reactively treating the surface layer.

2. The method as recited in claim 1 wherein the providing the surface layer is performed by applying a coating of the photocatalytic material to a substrate.

3. The method as recited in claim 2 wherein the reactively treating includes treating the surface layer with a gas flame by moving the coated substrate past the gas flame, a visible part of a flame tip of the gas flame being disposed about 10 mm to 20 mm above a surface of the substrate.

4. The method as recited in claim 1 wherein the reactively treating includes treating the surface layer with at least one of a plasma and a corona discharge.

5. The method as recited in claim 1 wherein the reactively treating includes treating the surface layer with a gas flame.

6. The method as recited in claim 5 wherein the treating the surface layer with a gas flame includes moving the surface layer past the gas flame, a visible part of a flame tip of the gas flame being disposed about 10 mm to 20 mm above the surface layer.

7. The method as recited in claim 6 wherein the moving the surface layer includes moving the surface layer past the gas flame at a rate of between 0.1 and 10 cm/s.

8. The method as recited in claim 7 wherein the rate is about 2.5 cm/s.

9. The method as recited in claim 5 further comprising supplying the gas flame with a fuel gas stream and an oxidant stream.

10. The method as recited in claim 1 wherein the activation process is performed at ambient atmosphere or under inert atmosphere.

11. The method as recited in claim 1 wherein the photocatalytic material includes titanium oxide.

12. The method as recited in claim 1 wherein the subjecting the surface layer to an activation process is performed so as to provide a non-fogging element.

13. The method as recited in claim 12 wherein the non-fogging element is a mirror.

14. The method as recited in claim 13 wherein the mirror is a traffic mirror.

15. The method as recited in claim 13 wherein the mirror is a motor vehicle mirror.

16. A device for activating a surface layer of an element, the surface layer including a photocatalytic material, the device comprising:
a conveying device configured to convey the element; and
a reactive treatment device associated with the conveying device and configured to reactively treat the surface layer.

17. The device as recited in claim 16 wherein the reactive treatment device includes at least one gas burner.

18. The device as recited in claim 17 wherein the conveying device is configured to convey the element past the at least one gas burner, and wherein the at least one gas burner is disposed relative to the conveying device so that a visible flame tip of a gas flame of the gas burner is disposed about 10 mm to 20 mm above the surface layer.

19. The device as recited in claim 17 wherein the at least one gas burner includes a plurality of gas burners each having at least one respective outlet disposed so that the respective gas burner is adapted to a contour of the surface layer.

20. A method for reactively treating an optical element, comprising:
applying a photocatalytic material to a substrate so as to provide a substantially transparently coated substrate; and
activating the coating using a gas burner.

21. The method as recited in claim 20 wherein the activating the coating includes moving the coated substrate past a gas flame of the gas burner.

22. The method as recited in claim 21 wherein a visible part of a flame tip of the gas flame is disposed about 10 mm to 20 mm above a surface of the coated substrate.
